(19) United States
(12) Patent Application Publication
(10) Pub. No.: US 2020/0361471 A1
(43) Pub. Date: Nov. 19, 2020

(54) METHOD AND APPARATUS FOR CONTROLLING A VEHICLE TO EXECUTE AN AUTOMATIC LANE CHANGE MANEUVER

(71) Applicant: GM Global Technology Operations LLC, Detroit, MI (US)

(72) Inventors: Gabriel T. Choi, Novi, MI (US); Paul A. Adam, Milford, MI (US); Xiaofeng F. Song, Novi, MI (US); Jeffrey S. Parks, Ann Arbor, MI (US); Braden J. Swantick, Canton, MI (US)

(73) Assignee: GM Global Technology Operations LLC, Detroit, MI (US)

(21) Appl. No.: 16/411,735

(22) Filed: May 14, 2019

(51) Int. Cl. B60W 30/18; G05D 1/02; B60W 30/14

(52) U.S. Cl. CPC B60W 30/18163; G05D 1/0223; B60W 30/143; B60W 2550/308; G05D 1/0257; B60W 2720/10; G05D 1/0231; G05D 1/0255; G05D 2201/0213

(57) ABSTRACT

A host vehicle that includes an autonomous control system that is capable of executing an automatic lane change (ALC) maneuver is described. The ALC maneuver may be executed when the host vehicle is seeking to merge into a lane of travel. This includes operating under conditions that include moderate to heavy levels of traffic. The host vehicle is capable of soliciting a desired gap in a target lane by using a lane centering offset maneuver to influence and observe proximal vehicles operating in the target lane before executing the ALC maneuver.

### INTRODUCTION

Driving assistance systems control various propulsion-related actuators based upon operator requests and sensed objects that are in a trajectory of a host vehicle. The propulsion-related actuators may include a propulsion system that generates tractive torque and a braking system that generates braking torque. Other actuators may provide for some level of steering control. Sensed objects that are in the trajectory of the host vehicle may include, by way of example, a forward vehicle in the same lane of travel and one or more vehicles operating in adjacent lanes of travel. On-vehicle sensing systems may include cameras, RADAR, LIDAR, combinations thereof, or another system.

On-vehicle driver assistance systems, such as advanced driver assistance systems (ADAS), provide levels of autonomous operation. Examples include, e.g., adaptive cruise control, lane keeping aids and lane change assistance. There is a need to provide an improved system for executing a lane change maneuver.

### SUMMARY

A host vehicle that includes an autonomous control system is described, and is capable of executing an automatic lane change (ALC) maneuver, such as a lane change on demand ALC maneuver. The ALC maneuver may be executed when the host vehicle is seeking to merge into a lane of travel. This includes operating under conditions that include moderate to heavy levels of traffic. The host vehicle is capable of soliciting a desired gap in a target lane by using a lane centering offset maneuver to influence and observe vehicles operating in the target lane before executing the ALC maneuver.

The method includes operating the host vehicle in an initial travel lane, identifying a target travel lane, and controlling a longitudinal speed of the host vehicle to operate at a desired speed that is equivalent to an average speed of a plurality of vehicles traveling in a target travel lane. A target gap is detected in the target travel lane, wherein the target gap is defined between a first of the plurality of vehicles and a second of the plurality of vehicles traveling in the target travel lane. Longitudinal speed of the host vehicle is controlled to position the host vehicle adjacent to the target gap in the target travel lane, and the host vehicle is controlled to execute a lane center offset maneuver towards the target travel lane while remaining in the initial travel lane. Parameters associated with the target gap in the target travel lane are monitored, and the autonomous control system executes a lane change maneuver to direct the host vehicle into the target travel lane when the parameters associated with the target gap exceed associated thresholds.

An aspect of the disclosure includes the autonomous control system including an adaptive cruise control system, wherein controlling the longitudinal speed of the host vehicle includes controlling the adaptive cruise control system to control the longitudinal speed of the host vehicle.

Another aspect of the disclosure includes the autonomous control system including an adaptive cruise control system and an autonomous steering system, wherein controlling the host vehicle to execute the lane center offset maneuver includes controlling the adaptive cruise control system to control the longitudinal speed of the host vehicle and controlling the autonomous steering system to execute the lane center offset maneuver towards the target travel lane.

Another aspect of the disclosure includes controlling the autonomous steering system to control the host vehicle to translate laterally towards the target travel lane while remaining in the initial travel lane.

Another aspect of the disclosure includes controlling the adaptive cruise control system to control the longitudinal speed of the host vehicle and controlling the autonomous steering system to control the host vehicle to execute the lane change maneuver to direct the host vehicle into the target travel lane.

Another aspect of the disclosure includes the target travel lane including a travel lane that is in same direction of travel and is adjacent to the initial travel lane.

Another aspect of the disclosure includes aborting execution of the lane change maneuver when any one of the parameters associated with the target gap is less than the associated threshold.

Another aspect of the disclosure includes monitoring a rearward gap associated with the first of the plurality of vehicles traveling in the target travel lane and monitoring a forward gap associated with the second of the plurality of vehicles traveling in the target travel lane.

Another aspect of the disclosure includes executing the lane change maneuver to direct the host vehicle into the target travel lane when the rearward gap is greater than a minimum rearward gap and when the forward gap is greater than a minimum forward gap.

Another aspect of the disclosure includes controlling a host vehicle including an autonomous control system, including operating the host vehicle in an initial travel lane, identifying a target travel lane, determining an average speed of a plurality of vehicles traveling in the target travel lane, controlling a longitudinal speed of the host vehicle to operate at a desired speed that is equivalent to the average speed of a plurality of vehicles traveling in the target travel lane, and detecting a plurality of target gaps in the target travel lane. Longitudinal speed of the host vehicle is controlled to position the host vehicle adjacent to a first of the target gaps in the target travel lane while monitoring parameters associated with the plurality of target gaps in the target travel lane. Execution of the lane change maneuver to the first of the target gaps is aborted when any one of the parameters associated with the first target gap is less than the associated threshold, and longitudinal speed of the host vehicle is controlled to position the host vehicle adjacent to a second of the target gaps in the target travel lane and continuing to monitor parameters associated with the plurality of target gaps in the target travel lane.

Another aspect of the disclosure includes controlling, via the autonomous control system, the host vehicle to execute a lane center offset maneuver at the second of the target gaps towards the target travel lane while remaining in the initial travel lane, monitoring parameters associated with the second of the target gaps in the target travel lane, and executing, via the autonomous control system, a lane change maneuver to direct the host vehicle into the target travel lane at the second of the target gaps when the parameters associated with the target gap exceed associated thresholds.

The above features and advantages, and other features and advantages, of the present teachings are readily apparent from the following detailed description of some of the best modes and other embodiments for carrying out the present teachings, as defined in the appended claims, when taken in connection with the accompanying drawings.

### BRIEF DESCRIPTION OF THE DRAWINGS

One or more embodiments will now be described, by way of example, with reference to the accompanying drawings, in which:

FIG. 1 schematically shows a top view of a vehicle including a configuration for autonomous propulsion control, in accordance with the disclosure.

FIG. 2 schematically shows a control schematic diagram that illustrates information flow between various on-vehicle sensors, actuators, and an ALC coordinator to effect the ALC maneuver, in accordance with the disclosure.

FIG. 3 shows a flowchart that is executed by the ALC coordinator to effect the ALC maneuver, in accordance with the disclosure.

FIGS. 4-7 pictorially show aspects related to execution of lane change maneuvers under various conditions, in accordance with the disclosure.

The appended drawings are not necessarily to scale, and present a somewhat simplified representation of various features of the present disclosure as disclosed herein, including, for example, specific dimensions, orientations, locations, and shapes. Details associated with such features will be determined in part by the particular intended application and use environment.

### DETAILED DESCRIPTION

The components of the disclosed embodiments, as described and illustrated herein, may be arranged and designed in a variety of different configurations. Thus, the following detailed description is not intended to limit the scope of the disclosure, as claimed, but is merely representative of possible embodiments thereof. In addition, while numerous specific details are set forth in the following description in order to provide a thorough understanding of the embodiments disclosed herein, some embodiments can be practiced without some of these details. Moreover, for the purpose of clarity, certain technical material that is understood in the related art has not been described in detail in order to avoid unnecessarily obscuring the disclosure.

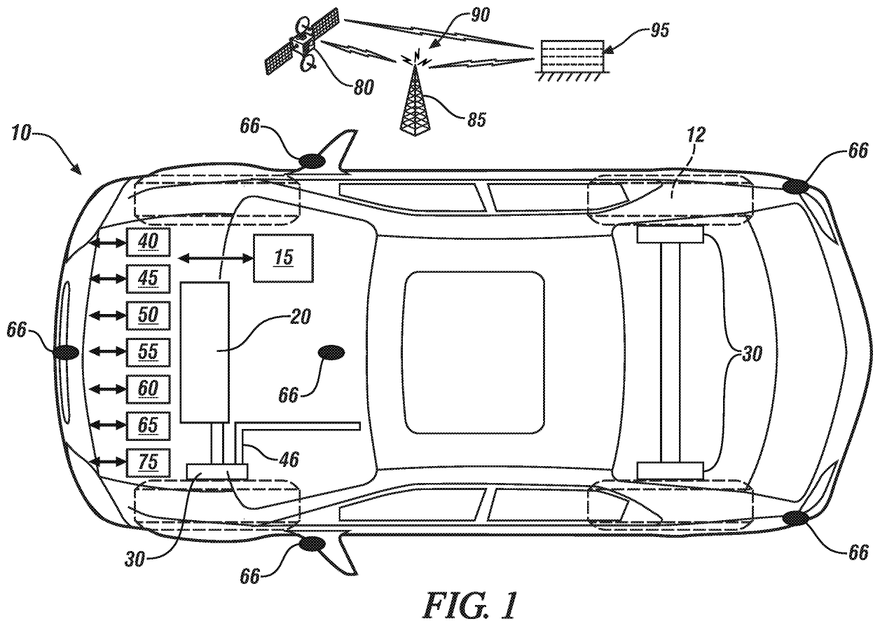

Referring now to the drawings, wherein the showings are for the purpose of illustrating certain exemplary embodiments and not for the purpose of limiting the same, FIG. 1 schematically shows an embodiment of a vehicle 10 that is configured with an autonomous operating system 45 that is disposed to provide a level of autonomous vehicle operation. In one embodiment and as described herein, the vehicle 10 includes a propulsion system 20, a wheel braking system 30, an adaptive cruise control (ACC) system 40, a Global Position System (GPS) sensor 50, a navigation system 55, a telematics device 60, a spatial monitoring system 65, a human-machine interface (HMI) system 75, and one or more controllers 15. The propulsion system 20 includes a prime mover, such as an internal combustion engine, an electric machine, a combination thereof, or another device. In one embodiment, the prime mover is coupled to a fixed gear or continuously variable transmission that is capable of transferring torque and reducing speed. The propulsion system 20 also includes a driveline, such as a differential, transaxle or another gear reduction mechanism. Operation of elements of the propulsion system 20 may be controlled by one or a plurality of controllers, which monitors signals from one or more sensors and generates commands to one or more actuators to control operation in a manner that is responsive to an operator request for vehicle acceleration and propulsion.

The wheel braking system 30 includes a device capable of applying braking torque to one or more vehicle wheels 12, and an associated controller, which monitors signals from one or more sensors and generates commands to one or more actuators to control operation in a manner that is responsive to an operator request for braking.

The ACC system 40 includes a controller that is in communication with the controllers of the wheel braking system 30, the propulsion system 20, and the HMI system 75, and also in communication with the spatial monitoring system 65. The ACC system 40 executes control routines that determine an operator request to maintain vehicle speed at a predefined speed level from the HMI system 75, monitors inputs from the spatial monitoring system 65, and commands operation of the propulsion system 20 and the wheel braking system 30 in response.

The terms controller, control module, module, control, control unit, processor and similar terms refer to various combinations of Application Specific Integrated Circuit(s) (ASIC), electronic circuit(s), central processing unit(s), e.g., microprocessor(s) and associated non-transitory memory component in the form of memory and storage devices (read only, programmable read only, random access, hard drive, etc.). The non-transitory memory component is capable of storing machine readable instructions in the form of one or more software or firmware programs or routines, combinational logic circuit(s), input/output circuit(s) and devices, signal conditioning and buffer circuitry and other components that can be accessed by one or more processors to provide a described functionality. Input/output circuit(s) and devices include analog/digital converters and related devices that monitor inputs from sensors, with such inputs monitored at a preset sampling frequency or in response to a triggering event. Software, firmware, programs, instructions, control routines, code, algorithms and similar terms mean controller-executable instruction sets including calibrations and look-up tables. Each controller executes control routine(s) to provide desired functions, including monitoring inputs from sensing devices and other networked controllers and executing control and diagnostic routines to control operation of actuators. Routines may be periodically executed at regular intervals, or may be executed in response to occurrence of a triggering event. Communication between controllers, and communication between controllers, actuators and/or sensors may be accomplished using a direct wired link, a networked communications bus link, a wireless link, a serial peripheral interface bus or another suitable communications link. Communication includes exchanging data signals in suitable form, including, for example, electrical signals via a conductive medium, electromagnetic signals via air, optical signals via optical waveguides, and the like. Data signals may include signals representing inputs from sensors, signals representing actuator commands, and communications signals between controllers.

The vehicle 10 includes a telematics device 60, which includes a wireless telematics communication system capable of extra-vehicle communications, including communicating with a communication network system having wireless and wired communication capabilities. The telematics device 60 is capable of extra-vehicle communications that includes short-range ad hoc vehicle-to-vehicle (V2V) communication and/or vehicle-to-everything (V2x) communication, which may include communication with an infrastructure monitor, e.g., a traffic camera and ad hoc vehicle communication. Alternatively or in addition, the telematics device 60 has a wireless telematics communication system capable of short-range wireless communication to a handheld device, e.g., a cell phone, a satellite phone or another telephonic device. In one embodiment the handheld device is loaded with a software application that includes a wireless protocol to communicate with the telematics device 60, and the handheld device executes the extra-vehicle communication, including communicating with an off-board controller 95 via a communication network 90 including a satellite 80, an antenna 85, and/or another communication mode. Alternatively or in addition, the telematics device 60 executes the extra-vehicle communication directly by communicating with the off-board controller 95 via the communication network 90.

The vehicle spatial monitoring system 65 includes a spatial monitoring controller in communication with a plurality of object-locating sensors 66. The vehicle spatial monitoring system 65 dynamically monitors an area proximate to the vehicle 10 and generates digital representations of observed or otherwise discerned remote objects. The spatial monitoring system 65 can determine a linear range, relative speed, and trajectory of each proximate remote object based upon information from one or a plurality of the object-locating sensors 66 employing sensor data fusion. The object-locating sensors 66 may include, by way of non-limiting descriptions, front corner sensors, rear corner sensors, rear side sensors, side sensors, a front radar sensor, and a camera in one embodiment, although the disclosure is not so limited. Placement of the object-locating sensors 66 permits the spatial monitoring system 65 to monitor traffic flow including proximate vehicles and other objects around the vehicle 10. Data generated by the spatial monitoring system 65 may be employed by a lane mark detection processor (not shown) to estimate the roadway. The object-locating sensors 66 may include range sensors, such as FM-CW (Frequency Modulated Continuous Wave) radars, pulse and FSK (Frequency Shift Keying) radars, and LIDAR (Light Detection and Ranging) devices, and ultrasonic devices which rely upon effects such as Doppler-effect measurements to locate forward objects. The object-locating sensors 66 may also include charged-coupled devices (CCD) or complementary metal oxide semi-conductor (CMOS) video image sensors, and other camera/video image processors which utilize digital photographic methods to ‘view’ forward and/or rear objects including one or more object vehicle(s). Such sensing systems are employed for detecting and locating objects in automotive applications and are useable with autonomous operating systems including, e.g., adaptive cruise control, autonomous braking, autonomous steering and side-object detection.

The object-locating sensors 66 associated with the spatial monitoring system 65 may be positioned within the vehicle 10 in relatively unobstructed positions. Each of these sensors provides an estimate of actual location or condition of a remote object, wherein said estimate includes an estimated position and standard deviation. As such, sensory detection and measurement of object locations and conditions are typically referred to as ‘estimates.’ The characteristics of the object-locating sensors 66 may be complementary in that some may be more reliable in estimating certain parameters than others. The object-locating sensors 66 may have different operating ranges and angular coverages capable of estimating different parameters within their operating ranges. For example, radar sensors may estimate range, range rate and azimuth location of a remote object, but are not normally robust in estimating the extent of a remote object. A camera with a vision processor is more robust in estimating a shape and azimuth position of a remote object, but may be less efficient at estimating the range and range rate of an object. Scanning type LIDAR sensors perform efficiently and accurately with respect to estimating range, and azimuth position, but typically cannot estimate range rate, and therefore may not be as accurate with respect to new object acquisition/recognition. Ultrasonic sensors are capable of estimating range but may be less capable of estimating or computing range rate and azimuth position. The performance of each of the aforementioned sensor technologies is affected by differing environmental conditions. Thus, some of the object-locating sensors 66 may present parametric variances during operation, although overlapping coverage areas of the sensors create opportunities for sensor data fusion. Sensor data fusion includes combining sensory data or data derived from sensory data from various sources that are observing a common field of view such that the resulting information is more accurate and precise than otherwise possible when these sources are used individually.

The HMI system 75 provides for human/machine interaction, for purposes of directing operation of an infotainment system, the GPS sensor 50, the vehicle navigation system, a remotely located service center and the like. The HMI system 75 monitors operator requests and provides information to the operator including status of vehicle systems, service and maintenance information. The HMI system 75 communicates with and/or controls operation of a plurality of in-vehicle operator interface device(s). The HMI system 75 may also communicate with one or more devices that monitor biometric data associated with the vehicle operator, including, e.g., eye gaze location, posture, and head position tracking, among others. The HMI system 75 is depicted as a unitary device for ease of description, but may be configured as a plurality of controllers and associated sensing devices in an embodiment of the system described herein. The in-vehicle operator interface device(s) can include devices that are capable of transmitting a message urging operator action, and can include an electronic visual display module, e.g., a liquid crystal display (LCD) device, a heads-up display (HUD), an audio feedback device, a wearable device and a haptic seat.

The vehicle 10 can include an autonomous operating system 45 that is disposed to provide a level of autonomous vehicle operation. The autonomous operating system 45 includes a controller and one or a plurality of subsystems that may include an autonomous steering system 46, the ACC system 40, an autonomous braking/collision avoidance system and/or other systems that are configured to command and control autonomous vehicle operation separate from or in conjunction with the operator requests. Autonomous operating commands may be generated to control the autonomous steering system 46, the ACC system 40, the autonomous braking/collision avoidance system and/or the other systems. Vehicle operation includes operation in one of the propulsion modes in response to desired commands, which can include operator requests and/or autonomous vehicle requests. Vehicle operation, including autonomous vehicle operation includes acceleration, braking, steering, steady-state running, coasting, and idling. Operator requests can be generated based upon operator inputs to an accelerator pedal, a brake pedal, a steering wheel, a transmission range selector, the ACC system 40, and a turn signal lever. Vehicle acceleration includes a tip-in event, which is a request to increase vehicle speed, i.e., accelerate the vehicle. A tip-in event can originate as an operator request for acceleration or as an autonomous vehicle request for acceleration. One non-limiting example of an autonomous vehicle request for acceleration can occur when a sensor for the ACC system 40 indicates that a vehicle can achieve a desired vehicle speed because an obstruction has been removed from a lane of travel, such as may occur when a slow-moving vehicle exits from a limited access highway. Braking includes an operator request to decrease vehicle speed. Steady-state running includes vehicle operation wherein the vehicle is presently moving at a rate of speed with no operator request for either braking or accelerating, with the vehicle speed determined based upon the present vehicle speed and vehicle momentum, vehicle wind resistance and rolling resistance, and driveline inertial drag, or drag torque. Coasting includes vehicle operation wherein vehicle speed is above a minimum threshold speed and the operator request to the accelerator pedal is at a point that is less than required to maintain the present vehicle speed. Idle includes vehicle operation wherein vehicle speed is at or near zero. The autonomous operating system 45 includes an instruction set that is executable to determine a trajectory for the vehicle 10, and determine present and/or impending road conditions and traffic conditions based upon the trajectory for the vehicle 10.

As used herein, the terms ‘dynamic’ and ‘dynamically’ describe steps or processes that are executed in real-time and are characterized by monitoring or otherwise determining states of parameters and regularly or periodically updating the states of the parameters during execution of a routine or between iterations of execution of the routine. The term “signal” refers to a physically discernible indicator that conveys information, and may be a suitable waveform (e.g., electrical, optical, magnetic, mechanical or electromagnetic), such as DC, AC, sinusoidal-wave, triangular-wave, square-wave, vibration, and the like, that is capable of traveling through a medium. The term ‘model’ refers to a processor-based or processor-executable code and associated calibration that simulates a physical existence of a device or a physical process. As used herein, the terms ‘dynamic’ and ‘dynamically’ describe steps or processes that are executed in real-time and are characterized by monitoring or otherwise determining states of parameters and regularly or periodically updating the states of the parameters during execution of a routine or between iterations of execution of the routine. The terms “calibration”, “calibrated”, and related terms refer to a result or a process that compares an actual or standard measurement associated with a device or system with a perceived or observed measurement or a commanded position for the device or system. A calibration as described herein can be reduced to a storable parametric table, a plurality of executable equations or another suitable form that may be employed as part of a measurement or control routine. A parameter is defined as a measurable quantity that represents a physical property of a device or other element that is discernible using one or more sensors and/or a physical model. A parameter can have a discrete value, e.g., either “1” or “0”, or can be infinitely variable in value.

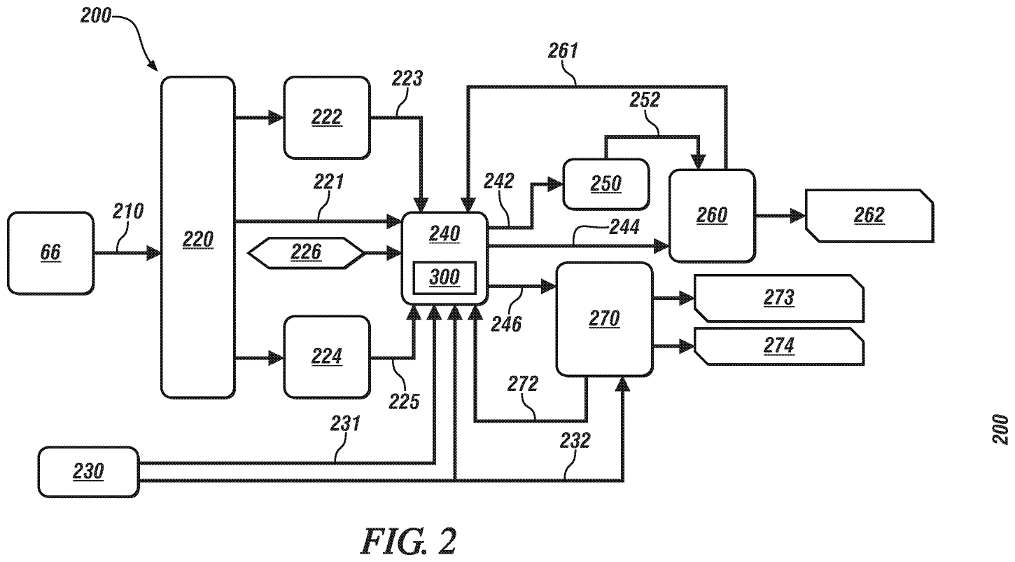

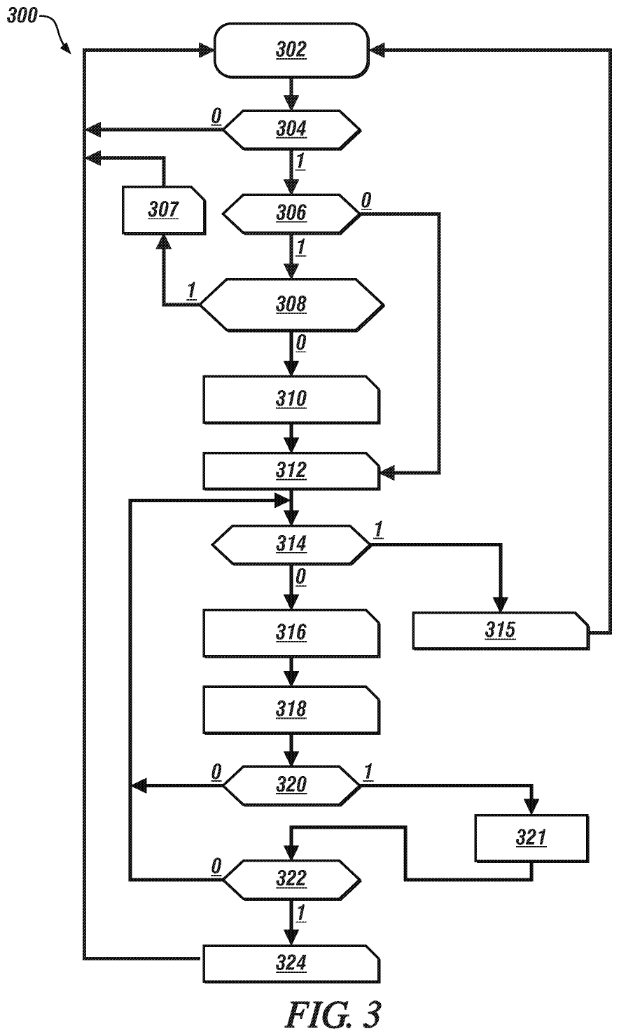

FIGS. 2 and 3 schematically illustrate details related to operating a host vehicle 100, e.g., an embodiment of the vehicle 10 that is described with reference to FIG. 1, to effect an automatic (ALC) maneuver, including when the host vehicle 100 is seeking to merge from an initial travel lane into a target travel lane, including under conditions that include moderate to heavy levels of traffic including proximal vehicles. A vehicle operator may initiate an ALC maneuver via the turn signal lever that is disposed on a steering column and in communication with the HMI controller 75, or via another command or request that can be interpreted by the HMI controller 75 as a request for execution of an ALC maneuver.

FIG. 2 schematically shows a control schematic diagram that illustrates information flow between various on-vehicle sensors, actuators, and an ALC coordinator 240 to effect the ALC maneuver, and FIG. 3 shows an example of an ALC control routine 300 that is executed by the ALC coordinator 240 to effect the ALC maneuver.

Referring now to FIG. 2, with continued reference to FIG. 1, inputs to the ALC coordinator 240 include signal inputs 210 originating from the sensors of the spatial monitoring system 65; vehicle speed 226 from vehicle operational sensors; and, operator requests 230, including e.g., a vehicle steering request, a desired vehicle speed, i.e., cruise control, and an ALC request, which may originate from the HMI system 75. Inputs to the ALC coordinator 240 may further include V2x communication via the telematics device 60. Outputs from the ALC coordinator 240 include commands to the autonomous operating system 45, including commands to the autonomous steering system 46, the ACC system 40, and the autonomous braking/collision avoidance system.

The signal inputs 210 that originate from the object-locating sensors 66 of the spatial monitoring system 65 include, by way of example, rearward long-range radar signals, rearview camera signals, rearward short-range radar signals, side blind-zone signals, frontward long-range radar signals, forward-view camera signals, and frontward short-range radar signals. The signal inputs 210 are communicate to a sensor fusion routine 220. The sensor fusion routine 220 combines data from the various sensors of the spatial monitoring system 65 to generate information related to position, orientation and situational awareness by augmenting incomplete information from individual ones of the sensors with information from one or more of the other sensors of the spatial monitoring system 65. The sensor fusion routine 220 is configured to execute a rearward/adjacent lane assessment 222 to detect and identify a rearward gap 223 between the host vehicle 100 and a rearward proximal vehicle that is operating in a target travel lane, and an attendant collision risk. The sensor fusion routine 220 is configured to execute a forward/adjacent lane assessment 224 to detect and identify a forward gap 225 between the host vehicle 100 and a forward proximal vehicle that is operating in the target travel lane, and an attendant collision risk. The sensor fusion routine 220 is configured to detect and parameterize a lateral gap in a target travel lane 221. The lateral gap in the target travel lane 221 may be in either the lane of travel to the immediate left of the host vehicle 100 or to the lane of travel to the immediate right of the host vehicle 100, wherein the host vehicle 100 is operating in the initial travel lane.

The vehicle speed 226 may be determined based upon signal inputs from wheel speed sensors or other sensors from which vehicle speed 226 may be determined. The operator requests 230 include the desired vehicle speed 232 and an ALC request 231, both which may originate from the HMI system 75.

The ALC coordinator 240 generates a plurality of control requests based upon the aforementioned signal inputs 210 originating from the sensors of the spatial monitoring system 65, vehicle speed 226, operator requests 230, and V2x communication via the telematics device 60, in conjunction with a position feedback 262 from a lane centering/lane change routine 260 and a target vehicle speed 272 from a control routine 270 associated with the ACC system 40.

The control requests from the ALC coordinator 240 include a lane centering offset request 242, an ALC execution command 244 and a desired vehicle speed 246.

The lane centering offset request 242 is provided as input to a dynamic offset routine 250, which dynamically determines a magnitude of lane center offset 252 for operating the host vehicle 100 based upon widths of the initial travel lane and the target travel lane, amount of road curvature, e.g., straight or winding, proximal vehicle speeds, and other factors. The magnitude of lane center offset for operating the host vehicle 100 is communicated to the lane centering/lane change routine 260, which generates a steering command 261 that is communicated to the autonomous steering system 46 for execution to achieve the lane centering offset request 242 while operating the host vehicle 100 in the initial travel lane. The ALC execution command 244 is a command that is communicated to the lane centering/lane change routine 260 to execute a lane change event, which generates the steering command 261 that is communicated to the autonomous steering system 46 for execution to achieve the lane change maneuver. The desired vehicle speed 246 is communicated to the ACC 40, which generates a propulsion torque command 273 or a braking command 274 to control operation of the propulsion system 20 and/or the wheel braking system 30.

FIG. 3 schematically shows the ALC routine 300 that is associated with the ALC coordinator 240. Table 1 is provided as a key wherein the numerically labeled blocks and the corresponding functions are set forth as follows, corresponding to the ALC routine 300. The teachings may be described herein in terms of functional and/or logical block components and/or various processing steps. Such block components may be composed of hardware, software, and/or firmware components that have been configured to perform the specified functions.

TABLE 1

| BLOCK | BLOCK CONTENTS |
|---|---|
| 302 | Operate ACC in present lane |
| 304 | Is there an ALC request? |
| 306 | Is Host Vx < Target Vx? |
| 308 | Is L_rear less than T1? OR |
| | Is \|Host Vx − Target Vx\| > T2? |
| 307 | Reject ALC request |
| 310 | Control Host Vx = Target Vx |
| 312 | Select target gap |
| 314 | Is target gap > permissible gap? |
| 315 | Execute ALC |
| 316 | Execute lane center offset maneuver |
| 318 | Monitor gaps, Target Vx |
| 320 | Select another target gap? |
| 322 | Is soliciting time greater than threshold? |
| 324 | Abort ALC |

Referring again to FIG. 3, and with continued reference to FIG. 2, execution of the ALC routine 300 may proceed as follows. The steps of the ALC routine 300 may be executed in a suitable order, and are not limited to the order described with reference to FIG. 3. As employed herein, the term “1” indicates an answer in the affirmative, or “YES”, and the term “0” indicates an answer in the negative, or “NO”. The ALC routine 300 includes initially controlling vehicle operation employing the ACC system 40 in an initial, present lane of travel (302), including monitoring the inputs to the ALC coordinator 240 including the signal inputs 210 originating from the sensors of the spatial monitoring system 65, the vehicle speed 226, and the operator requests 230. The signal inputs from the sensors of the spatial monitoring system 65 are evaluated to determine various parameters, including average speeds of travel of proximal vehicles in leftward and/or rightward lanes of travel, which compose target travel lane(s) into which the host vehicle 100 may request a lane change. The parameters include the outputs from the sensor fusion routine 220, include the rearward gap 223, the forward gap 225, and the lateral gap in the target travel lane 221. This also includes the vehicle speed 226.

This includes monitoring inputs to detect an ALC request by the vehicle operator, and identify a target travel lane (304). This iteration ends when there has been no ALC request (304)(0). When there has been an ALC request (304)(1), various parameters are evaluated, including comparing the host vehicle speed, i.e., vehicle speed 226 (Host Vx) with the average speed of the proximal vehicles in the target travel lane (Target Vx) (306). When the host vehicle speed, i.e., vehicle speed 226 is less than the average speed of the proximal vehicles in the target travel lane (306)(1), the evaluation continues at step 308. When the host vehicle speed, i.e., vehicle speed 226 is equal to the average speed of the proximal vehicles in the target travel lane (306)(0), the evaluation skips Steps 308 and 310, and advances to Step 312.

At step 308, the rearward gap 223 is compared to a first threshold T1, i.e., a minimum rearward gap, and an absolute difference between the vehicle speed 226 and the average speed of the proximal vehicles in the target travel lane is compared to a second threshold T2. When the rearward gap 223 is less than the first threshold T1, or the absolute difference between the vehicle speed 226 and the average speed of the proximal vehicles in the target travel lane is greater than the second threshold T2 (308)(1), the ALC request is rejected (307), and this iteration ends.

When the rearward gap 223 is greater than the first threshold T1, and the absolute difference between the vehicle speed 226 and the average speed of the proximal vehicles in the target travel lane is less than the second threshold T2 (308)(0), operation of the host vehicle 100 is controlled such the vehicle speed 226 matches the average speed of the proximal vehicles in the target travel lane (310), and a target gap between two proximal vehicles in the target travel lane is selected (312). The target gap is evaluated to determine if there is sufficient space in the target lane to effect the ALC maneuver (314), and if so (314)(1), the ALC maneuver is executed (315). This includes verifying that the rearward gap 223 is greater than the minimum rearward gap and verifying that the forward gap 225 is greater than a minimum forward gap, such that there is sufficient room for the host vehicle 100 to execute the ALC maneuver. This can be determined based upon vehicle speed, and length of the host vehicle 100 including a trailer if so equipped. The gap can also take into account the operator's head-way setting for the ACC system, i.e., one of far, medium, or close.

When there is insufficient space in the target lane to effect the ALC maneuver (314)(0), a lane center offset maneuver is executed (316). During vehicle operation, the host vehicle 100 is controlled to travel in the center of the initial travel lane. The lane center offset maneuver includes controlling the vehicle speed 226 of the host vehicle 100 to position the host vehicle 100 adjacent to the target gap in the target travel lane, and controlling the host vehicle 100 to remain in the initial travel lane while executing a lateral shift towards the target travel lane. This lateral shift may be in the order of magnitude of 6 to 18 inches, depending upon the width of the initial travel lane. The purpose of the lateral shift is to solicit, from one or more of the operators of the proximal vehicles traveling in the target travel lane, a change in speed that results in an increase in the longitudinal length of the target gap sufficient to permit the host vehicle 100 to execute the ALC maneuver.

During continued operation, other potential gaps in the target travel lane are monitored in conjunction with monitoring the speeds of the proximal vehicles in the target travel lane (318). When the other potential gaps in the target travel lane do not appear to afford an opportunity for executing a ALC maneuver (320)(0), the operation continues with continued monitoring of the selected target gap via Steps 314, et seq. When one of the other potential gaps in the target travel lane appear to afford an opportunity for executing a ALC maneuver (320)(1), the operation continues by changing the selected target gap to another of the potential gaps (321), verifying that a time threshold has not been exceeded (322)(0), and adjusting vehicle operation to position the host vehicle 100 to monitor of the newly selected target gap via Steps 314, et seq. If the time threshold has been exceeded (322)(1), the ALC request is aborted (324), and the host vehicle 100 is returned to the center of the initial travel lane awaiting further instruction from the vehicle operator.

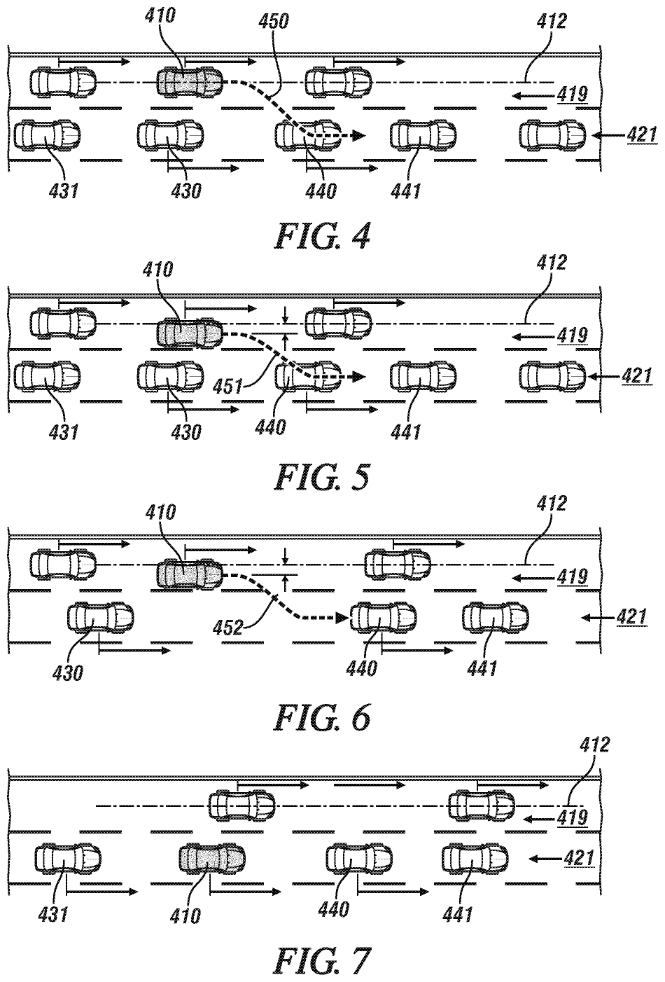

FIGS. 4-7 pictorially show aspects related to execution of lane change maneuvers under various conditions, including a host vehicle 410 traveling on an initial travel lane 419, and a plurality of rearward proximal vehicles 430, 431 and a plurality of forward proximal vehicles 440, 441 that are operating in a target travel lane 421.

Referring specifically to FIG. 4, the host vehicle 410 is traveling in the initial travel lane 419, with host vehicle 410 being centered at a lane center 412 of the initial travel lane 419. A lane change trajectory 451 is indicated, which interferes with the forward proximal vehicle 440, thus making a lane change maneuver unachievable.

Referring specifically to FIG. 5, the host vehicle 410 is traveling in the initial travel lane 419, with the host vehicle 410 executing a lane change soliciting action by executing a lane center offset maneuver, as described with reference to FIG. 3. The host vehicle 410 solicits a lane change by controlling its vehicle speed to position the host vehicle 410 adjacent to the target gap in the target travel lane 421, and controlling the host vehicle 410 to remain in the initial travel lane 419 while executing the lane center offset maneuver by executing a lateral shift towards the target travel lane 421. A lane change trajectory 451 is indicated, which interferes with the forward proximal vehicle 440, thus making a lane change maneuver unachievable.

Referring specifically to FIG. 6, the host vehicle 410 is traveling in the initial travel lane 419, with the host vehicle 410 executing a lane change soliciting action by executing a lane center offset maneuver, as described with reference to FIG. 3. The host vehicle 410 solicits a lane change by controlling its vehicle speed to position the host vehicle 410 adjacent to the target gap in the target travel lane 421, and controlling the host vehicle 410 to remain in the initial travel lane 419 while executing the lane center offset maneuver by executing a lateral shift towards the target travel lane 421. One of the rearward proximal vehicles 430 has apparently adjusted its speed, opening the target gap to a level that is sufficient to permit execution of the ALC maneuver. A lane change trajectory 452 is indicated, which does not interfere with the forward proximal vehicle 440, thus making a lane change maneuver achievable.

Referring specifically to FIG. 7, the host vehicle 410 has successfully executed the ALC maneuver, and is traveling in the target travel lane 421.

The concepts described herein include executing an ALC maneuver in a coordinated fashion to solicit a desired gap in the target lane from the surrounding traffic, hence confirming that vehicle operators in the target lane are aware and accept intent of the host vehicle to move into the target lane. Overall, the concepts include soliciting a desired gap in the target lane by influencing and observing response of one or more target proximal vehicles in the target lane, using offset from the center of the host lane. This includes an ability to secure tail-way before attempting lane change, an ability to dynamically switch to different target gap in response to the road situation, and an ability to reject a lane change request after soliciting a desired gap in the busy lane fails.

The flowchart and block diagrams in the flow diagrams illustrate the architecture, functionality, and operation of possible implementations of systems, methods, and computer program products according to various embodiments of the present disclosure. In this regard, each block in the flowchart or block diagrams may represent a module, segment, or portion of code, which includes one or more executable instructions for implementing the specified logical function(s). It will also be noted that each block of the block diagrams and/or flowchart illustrations, and combinations of blocks in the block diagrams and/or flowchart illustrations, may be implemented by dedicated-function hardware-based systems that perform the specified functions or acts, or combinations of dedicated-function hardware and computer instructions. These computer program instructions may also be stored in a computer-readable medium that can direct a computer or other programmable data processing apparatus to function in a particular manner, such that the instructions stored in the computer-readable medium produce an article of manufacture including instruction set that implements the function/act specified in the flowchart and/or block diagram block or blocks.

The detailed description and the drawings or figures are supportive and descriptive of the present teachings, but the scope of the present teachings is defined solely by the claims. While some of the best modes and other embodiments for carrying out the present teachings have been described in detail, various alternative designs and embodiments exist for practicing the present teachings defined in the appended claims.

What is claimed is:

1. Method for controlling a host vehicle, wherein the host vehicle includes an autonomous control system, the method comprising:
operating the host vehicle in an initial travel lane;
identifying a target travel lane;
determining an average speed of a plurality of proximal vehicles traveling in the target travel lane;
controlling a longitudinal speed of the host vehicle to operate at a desired speed that is equivalent to the average speed of a plurality of proximal vehicles traveling in the target travel lane;
detecting a target gap in the target travel lane, wherein the target gap is defined between a first of the plurality of proximal vehicles and a second of the plurality of proximal vehicles traveling in the target travel lane;
controlling longitudinal speed of the host vehicle to position the host vehicle adjacent to the target gap in the target travel lane;
controlling, via the autonomous control system, the host vehicle to execute a lane center offset maneuver towards the target travel lane while remaining in the initial travel lane;
monitoring parameters associated with the target gap in the target travel lane;
executing, via the autonomous control system, a lane change maneuver to direct the host vehicle into the target travel lane when the parameters associated with the target gap exceed associated thresholds for the parameters.

2. The method of claim 1, wherein the autonomous control system includes an adaptive cruise control system, and wherein controlling the longitudinal speed of the host vehicle comprising controlling the adaptive cruise control system to control the longitudinal speed of the host vehicle.

3. The method of claim 1, wherein the autonomous control system includes an adaptive cruise control system and an autonomous steering system, and wherein controlling the host vehicle to execute the lane center offset maneuver comprises controlling the adaptive cruise control system to control the longitudinal speed of the host vehicle and controlling the autonomous steering system to execute the lane center offset maneuver towards the target travel lane.

4. The method of claim 3, wherein controlling the autonomous steering system to execute the lane center offset maneuver towards the target travel lane while remaining in the initial travel lane comprises controlling the autonomous steering system to control the host vehicle to translate laterally towards the target travel lane while remaining in the initial travel lane.

5. The method of claim 3, further comprising controlling the adaptive cruise control system to control the longitudinal speed of the host vehicle and controlling the autonomous steering system to control the host vehicle to execute the lane change maneuver to direct the host vehicle into the target travel lane.

6. The method of claim 1, wherein the target travel lane comprises a travel lane that is in same direction of travel and is adjacent to the initial travel lane.

7. The method of claim 1, further comprising aborting execution of the lane change maneuver when any one of the parameters associated with the target gap is less than the associated threshold for the parameter.

8. The method of claim 1, wherein monitoring parameters associated with the target gap in the target travel lane comprises monitoring a rearward gap associated with the first of the plurality of proximal vehicles traveling in the target travel lane and monitoring a forward gap associated with the second of the plurality of proximal vehicles traveling in the target travel lane.

9. The method of claim 8, wherein executing, via the autonomous control system, the lane change maneuver to direct the host vehicle into the target travel lane when the parameters associated with the target gap exceed associated thresholds comprises executing the lane change maneuver to direct the host vehicle into the target travel lane when the rearward gap is greater than a minimum rearward gap and when the forward gap is greater than a minimum forward gap.

10. A host vehicle, comprising:
a propulsion system coupled to a drive wheel;
a steerable wheel;
an autonomous control system, including an adaptive cruise control system coupled to the propulsion system and an autonomous steering control system coupled to the steerable wheel;
a plurality of object-locating sensors disposed to monitor an area proximate to the vehicle;
a controller, in communication with the autonomous control system and the object-locating sensors, the controller including a memory device including an instruction set, the instruction set executable to:
operate the host vehicle in an initial travel lane;
identify a target travel lane;
determine an average speed of a plurality of proximal vehicles traveling in the target travel lane;
control a longitudinal speed of the host vehicle to operate at a desired speed that is equivalent to the average speed of a plurality of proximal vehicles traveling in the target travel lane;
detect a target gap in the target travel lane, wherein the target gap is defined between a first of the plurality of proximal vehicles and a second of the plurality of proximal vehicles traveling in the target travel lane;
control a longitudinal speed of the host vehicle to position the host vehicle adjacent to the target gap in the target travel lane;
control, via the autonomous control system, the host vehicle to execute a lane center offset maneuver towards the target travel lane while remaining in the initial travel lane;
monitor parameters associated with the target gap in the target travel lane;
execute, via the autonomous control system, a lane change maneuver to direct the host vehicle into the target travel lane when the parameters associated with the target gap exceed associated thresholds.

11. The host vehicle of claim 10, wherein the autonomous control system includes an adaptive cruise control system, and wherein the instruction set executable to control the longitudinal speed of the host vehicle comprises the instruction set executable to control the adaptive cruise control system to control the longitudinal speed of the host vehicle.

12. The host vehicle of claim 11, wherein the autonomous control system includes an adaptive cruise control system and an autonomous steering system, and wherein the instruction set executable to control the host vehicle to execute the lane center offset maneuver comprises the instruction set executable to control the adaptive cruise control system to control the longitudinal speed of the host vehicle and control the autonomous steering system to execute the lane center offset maneuver towards the target travel lane.

13. The host vehicle of claim 12, wherein the instruction set executable to control the autonomous steering system to execute the lane center offset maneuver towards the target travel lane while remaining in the initial travel lane comprises the instruction set executable to control the autonomous steering system to control the host vehicle to translate laterally towards the target travel lane while remaining in the initial travel lane.

14. The host vehicle of claim 12, further comprising the instruction set executable to control the adaptive cruise control system to control the longitudinal speed of the host vehicle and control the autonomous steering system to control the host vehicle to execute the lane change maneuver to direct the host vehicle into the target travel lane.

15. The host vehicle of claim 10, wherein the target travel lane comprises a travel lane that is in same direction of travel and is adjacent to the initial travel lane.

16. The host vehicle of claim 10, further comprising the instruction set executable to abort the execution of the lane change maneuver when any one of the parameters associated with the target gap is less than the associated threshold.

17. The host vehicle of claim 10, wherein the instruction set executable to monitor parameters associated with the target gap in the target travel lane comprises the instruction set executable to monitor a rearward gap associated with the first of the plurality of proximal vehicles traveling in the target travel lane and monitor a forward gap associated with the second of the plurality of proximal vehicles traveling in the target travel lane.

18. The host vehicle of claim 17, wherein the instruction set executable to execute, via the autonomous control system, the lane change maneuver to direct the host vehicle into the target travel lane when the parameters associated with the target gap exceed associated thresholds comprises the instruction set executable to execute the lane change maneuver to direct the host vehicle into the target travel lane when the rearward gap is greater than a minimum rearward gap and when the forward gap is greater than a minimum forward gap.

19. A method for controlling a host vehicle, wherein the host vehicle includes an autonomous control system, the method comprising:
operating the host vehicle in an initial travel lane;
identifying a target travel lane;
determining an average speed of a plurality of proximal vehicles traveling in the target travel lane;
controlling a longitudinal speed of the host vehicle to operate at a desired speed that is equivalent to the average speed of a plurality of proximal vehicles traveling in the target travel lane;
detecting a plurality of target gaps in the target travel lane;
controlling longitudinal speed of the host vehicle to position the host vehicle adjacent to a first of the target gaps in the target travel lane and continuing to monitor parameters associated with the plurality of target gaps in the target travel lane;
aborting execution of the lane change maneuver to the first of the target gaps when any one of the parameters associated with the first target gap is less than the associated threshold; and
controlling longitudinal speed of the host vehicle to position the host vehicle adjacent to a second of the target gaps in the target travel lane and continuing to monitor parameters associated with the plurality of target gaps in the target travel lane.

20. The method of claim 19, further comprising controlling, via the autonomous control system, the host vehicle to execute a lane center offset maneuver at the second of the target gaps towards the target travel lane while remaining in the initial travel lane;
monitoring parameters associated with the second of the target gaps in the target travel lane; and
executing, via the autonomous control system, a lane change maneuver to direct the host vehicle into the target travel lane at the second of the target gaps when the parameters associated with the target gap exceed associated thresholds.
